(19) United States
(12) Patent Application Publication
(10) Pub. No.: US 2023/0202555 A1
(43) Pub. Date: Jun. 29, 2023

(54) STEERING CONTROL DEVICE AND METHOD

(71) Applicant: HL MANDO CORPORATION, Gyeonggi-do (KR)

(72) Inventor: JungAe LEE, Seoul (KR)

(21) Appl. No.: 18/088,732

(22) Filed: Dec. 26, 2022

(30) Foreign Application Priority Data
Dec. 27, 2021 (KR) 10-2021-0188313

(51) Int. Cl. B62D 5/04; B62D 15/02

(52) U.S. Cl. CPC B62D 5/0484; B62D 15/024

(57) ABSTRACT

The embodiments relate to a steering control device and method. Specifically, a steering control device according to an embodiment may include a first steering control module configured to receive steering information, determine a target rack position based on the steering information, and generate a first command current to control a steering motor so that a rack moves to the target rack position, and a second steering control module configured to receive a control right for the steering motor if the first steering control module fails, and generate a second command current for controlling the steering motor.

### CROSS REFERENCE TO RELATED APPLICATION

This application claims priority from Korean Patent Application No. 10-2021-0188313, filed on Dec. 27, 2021, which is hereby incorporated by reference for all purposes as if fully set forth herein.

### TECHNICAL FIELD

Embodiments of the present disclosure relate to a steering control device and method.

Recently, the development of vehicle safety control systems is rapidly performed according to the needs of consumers. These safety systems are applied to various fields such as steering, braking, and suspension, and are recently implemented in various ways using electronic components.

In particular, as a steering assistance system for assisting steering of a vehicle, there is developed a steering assistance system having a redundant system for controlling steering of a vehicle by using two or more controllers. In such a redundant system, two or more controllers may be installed, and if one controller fails, another controller performs a control operation, thereby providing higher driving stability.

However, if communication between two controllers that transmit and receive data to each other is imposible, there is a disadvantage in that the function of the redundant system cannot be provided since the standby controller cannot replace the failed controller.

### SUMMARY

In this background, embodiments of the present disclosure provide a steering control device and method capable of determining whether the steering control module under control fails in the case that a first steering control module and a second steering control module cannot transmit and receive data to each other by including respective motor position sensor (MPS).

In an aspect of the present disclosure, there is provided a steering control device including a first steering control module configured to receive steering information, determine a target rack position based on the steering information, and generate a first command current to control a steering motor so that a rack moves to the target rack position, and a second steering control module configured to receive a control right for the steering motor if the first steering control module fails, and generate a second command current for controlling the steering motor.

In another aspect of the present disclosure, there is provided a steering control method including receiving steering information from a first steering control module, detecting a failure of the first steering control module based on the steering information, and transitioning a control right of a steering motor, if it is determined that the first steering control module fails, to a second steering control module.

According to embodiments of the steering control device and method according to the present disclosure, it is possible to provide the stability in driving by including the respective motor position sensor (MPS) in each of the first steering control module and the second steering control module.

### BRIEF DESCRIPTION OF THE DRAWINGS

FIG. 1 schematically illustrates a steering control system according to an embodiment of the present disclosure.

FIG. 2 is a block diagram for briefly explaining a steering control device according to an embodiment of the present disclosure.

FIG. 3 illustrates a first steering control module according to an embodiment.

FIG. 4 is a diagram for describing transition of a control right to a second steering control module in the case of a failure of a first steering control module according to an exemplary embodiment.

FIG. 5 is a diagram for explaining detection of a failure of a first steering control module through a second MPS according to an embodiment.

FIG. 6 is a flowchart illustrating a steering control method according to an embodiment of the present disclosure.

FIG. 7 is a diagram for explaining step S620 in detail according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

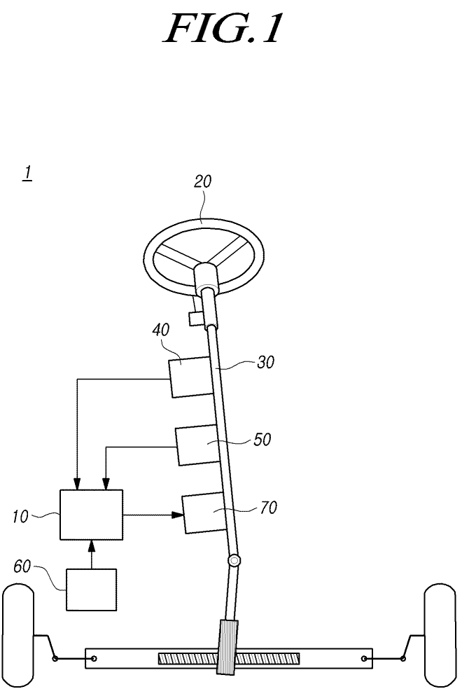

FIG. 1 schematically illustrates a steering control system 1 according to an embodiment of the present disclosure.

Referring to FIG. 1, a steering control system 1 according to an embodiment may refer to a system that controls to change the steering of a vehicle equipped with the steering control system 1 according to a rotational angle of a steering wheel operated by a driver.

According to the driving method, the steering control system 1 may include a hydraulic power steering (HPS) for generating hydraulic pressure by turning a pump to provide steering assist power, and an electronic power steering (EPS) control system for providing steering assistance power by driving a motor.

Meanwhile, depending on whether the steering input actuator and the steering output actuator are connected with a mechanical connecting member (or linkage), the steering control system 1 may be a mechanical steering control system in which the force (torque) generated when the driver rotates the steering wheel 20 is transmitted to the steering motor 70 through a mechanical power transmission device (e.g., linkage, etc.), and the steering motor 70 steers the wheel. Alternatively, the steering control system 1 may be a steer-by-wire (SbW) system which transmits power by transmitting and receiving electrical signals through wires and cables instead of mechanical power transmission devices. Hereinafter, the steering control system 1 will be described based on the EPS system, but is not limited thereto.

Referring to FIG. 1, the steering control system 1 according to the present disclosure may include a steering control device 10, a steering wheel 20, a shaft 30, a steering angle sensor 40, a torque sensor 50, a speed sensor 60, and a steering motor 70.

The steering wheel 20 may be rotated by a driver’s manipulation. The steering wheel 20 may be coupled to the shaft 30. The shape of the steering wheel 20 may be circular as shown in FIG. 1, but is not limited thereto.

The shaft 30 may be coupled to the steering wheel 20 and rotated together with the steering wheel 20. The shape of the shaft 30 may be cylindrical.

Although not shown, the shaft 30 may include a plurality of reducers, and any one of the plurality of reducers may be coupled to an outer circumferential surface of the shaft 30.

Although not shown, the steering control system 1 according to the present disclosure may include a steering column including a shaft 30 and a reducer.

The steering angle sensor 40 may detect a steering angle generated by rotation of the steering wheel 20. In addition, the steering angle sensor 40 may output a steering angle signal indicating information on the steering angle.

Here, the steering angle may not generally be detected unless the steering wheel 20 rotates, and the corresponding steering angle signal may not be output unless the steering wheel 20 rotates.

The torque sensor 50 may detect steering torque generated by rotation of the steering wheel 20. In addition, if the steering torque is detected, the torque sensor 50 may output a steering torque signal indicating information on the steering torque.

Here, the steering torque may mean torque applied to the torsion bar disposed between an input shaft and an output shaft of the shaft 30. Therefore, steering torque may be detected even if the steering wheel 20 is not rotated.

The speed sensor 60 may detect a speed of the vehicle and output a vehicle speed signal indicating information on the vehicle speed.

The steering control device 10 may receive steering information, determine a target rack position for providing steering assistance force, and output a command current corresponding to the rack position to the steering motor 170. Here, the steering information may include information included in a steering angle signal output by the steering angle sensor 40, a steering torque signal output by the torque sensor 50, and a vehicle speed signal output by the speed sensor 60. The steering control device 10 may receive the steering angle signal, the steering torque signal and the vehicle speed signal.

This steering control device 10 may be implemented with hardware such as an electronic control unit (ECU) including a micro controller unit (MCU), an inverter, a printed circuit board (PCB), and software.

The steering motor 170 may receive a command current from the steering control device 10 and may be driven with torque and rotational speed according to the command current. Although not shown, the steering motor 170 may be combined with a reducer disposed on the shaft 30. Rotation of the steering motor 170 may rotate the reducer disposed on the shaft 30 and the shaft 30.

Meanwhile, the shaft is rotated due to the rotation of the steering motor 170, and the wheels are moved left or right by the operation of the rack and pinion gear or the worm gear, so that the vehicle can turn.

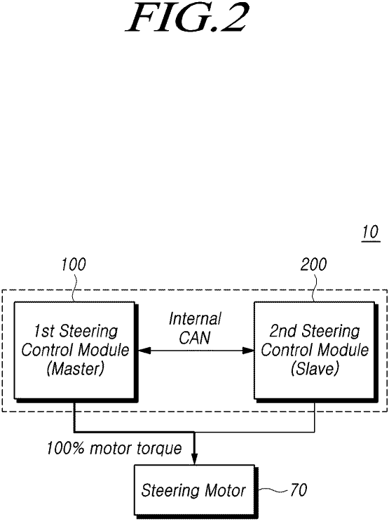

FIG. 2 is a block diagram for briefly explaining a steering control device according to an embodiment of the present disclosure.

Referring to FIG. 2, the steering control device 10 of the present disclosure may include a first steering control module 100 and a second steering control module 200.

In addition, in the steering control device 10, one of the first steering control module 100 and the second steering control module 200 may have a control right for the steering motor 70 and, as described above, may receive steering information to determine a target rack position and output a command current so that the rack moves to the determined target rack position.

FIG. 2 illustrates a case in which the first steering control module 100 has a control right and controls so that 100% motor torque is output.

The first steering control module 100 and the second steering control module 200 may transmit and receive data with each other. Here, the data transmission/reception path may use a controller area network (CAN) capable of communicating with modules installed in the vehicle, or an internal CAN connected between the first steering control module 100 and the second steering control module 200.

The first steering control module 100 and the second steering control module 200 may transmit and receive data such as steering information, state information on each module, a target rack position, and a rack position.

Although not shown, the first steering control module 100 and the second steering control module 200 may receive voltage from a battery installed in the vehicle, may receive voltage from the same battery, or may each receive voltages from different batteries.

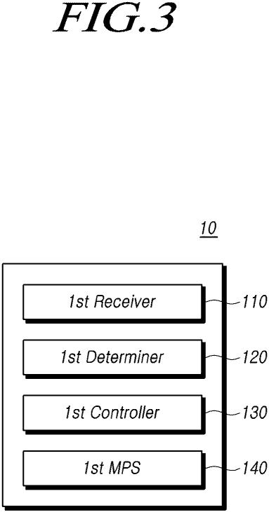

FIG. 3 illustrates a first steering control module according to an embodiment.

Referring to FIG. 3, the first steering control module 100 may include a first receiver 110, a first determiner 120, a first controller 130, and a first motor position sensor (MPS) 140.

The first receiver 110 may receive steering information from at least one of a speed sensor, a steering angle sensor, and a torque sensor.

The first determiner 120 may determine a target rack position for providing a steering assistance force based on the steering information.

The first controller 130 may generate a first command current so that the rack moves to the target rack position. In addition, the first controller 130 may determine a failure of the first steering control module 100 and the second steering control module 200 based on the steering information.

The first MPS 140 may detect a position of the steering motor 70. The first MPS 140 may detect the motor position of the steering motor 70 and transmit the detected motor position to the first controller 130 so as for the first controller 130 to determine whether of the failure.

The second steering control module 200 may be a module to replace the first steering control module 100 in a state where the first steering control module 100 cannot function properly, that is, a state in which the first steering control module 100 fails. The second steering control module 200 may include the same configuration as the first steering control module 100. Accordingly, the steering control device 10 may be implemented as a redundant system by including the first steering control module 100 and the second steering control module 200. Accordingly, the second steering control module 200 may include a second receiver, a second determiner, a second controller, and a second MPS 240.

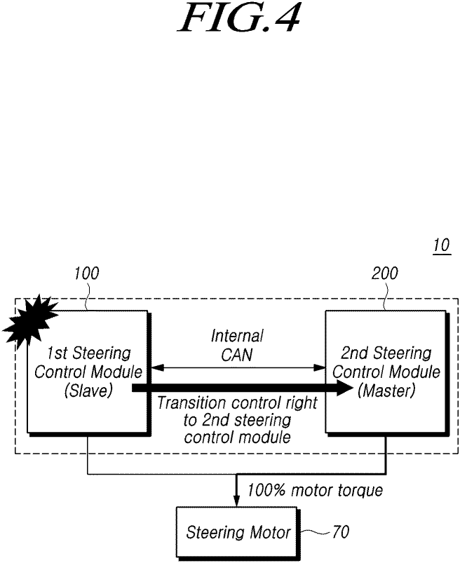

FIG. 4 is a diagram for describing transition of a control right to a second steering control module 200 in the case of a failure of a first steering control module 100 according to an exemplary embodiment.

Referring to FIG. 4, the first steering control module 100 may receive steering information, determine a target rack position based on the steering information, and generate a first command current to control the steering motor 70 so that the rack moves to the target rack position. In addition, if the first steering control module 100 fails, the second steering control module 200 may receive a control right for the steering motor 70 and generate a second command current for controlling the steering motor 70.

Specifically, if a failure is detected in the first steering control module 100, the control right of the steering motor 70 maintained by the first steering control module 100 may be transferred or transitioned to the second steering control module 200. Accordingly, the first steering control module 100 may be changed from a master state to a slave state, and the second steering control module 200 may be changed from a slave state to a master state. In addition, the second steering control module 200 may determine a target rack position based on the steering information and generate a second command current for providing steering assistance force as shown in FIG. 4.

In one embodiment, the failure determination of the first steering control module 100 may be performed by the first steering control module 100 itself, and the first steering control module 100 may transmit own state information to the second steering control module 200 through an internal CAN. In this case, the second steering control module 200 may determine a failure of the first steering control module 100 based on the data received through the internal CAN.

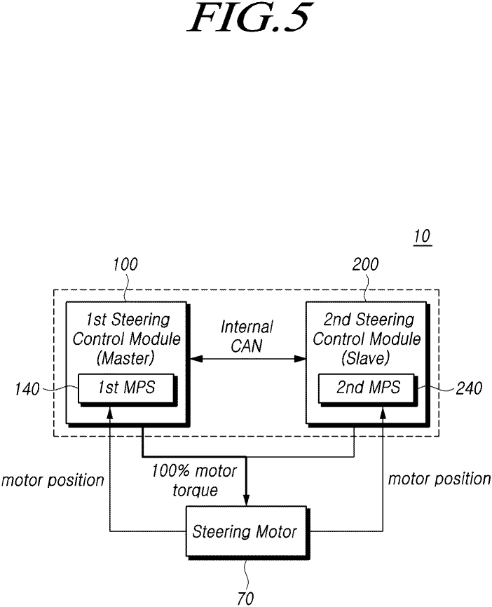

FIG. 5 is a diagram for explaining detection of a failure of a first steering control module 100 through a second MPS 240 according to an embodiment.

Referring to FIG. 5, the first steering control module 100 and the second steering control module 200 may each include an MPS for detecting the position of the steering motor 70. That is, the first steering control module 100 may include a first MPS 140 and the second steering control module 200 may include a second MPS 240. Each steering control module may receive information on the position of the steering motor 70 detected by each MPS.

The first steering control module 100 and the second steering control module 200 may determine a failure the first steering control module 100 or the second steering control module 200 based on the position of the steering motor 70.

Specifically, the first steering control module 100 and the second steering control module 200 may determine whether the first steering control module 100 fails based on an estimated rack position estimated by moving a rack as the steering motor rotates and the target rack position. Here, the first steering control module 100 and the second steering control module 200 may determine that the first steering control module 100 fails if the difference between the estimated rack position and the target rack position is equal to or greater than a predetermined distance.

Alternatively, as described above, it is possible to determine a failure of the second steering control module 200 based on the estimated rack position and the target rack position. This case may be a situation in which the second steering control module 200 maintains the control right of the steering motor 70.

In addition, if the second steering control module 200 does not receive steering information from the first steering control module 100, the second steering control module 200 may determine a failure of the first steering control module 100 based on the position of the steering motor 70 detected by the second MPS 240.

In addition, the first steering control module 100 may determine that the first steering control module 100 fails if it is detected that the steering motor 70 does not rotate while the steering wheel is rotating. Specifically, if the steering wheel rotates, there may be generated steering information such as a rotation angle of the steering wheel or steering torque detected by a torque sensor. In this case, the first steering control module 100 maintaining the control right of the steering motor 70 determines the target rack position based on the steering information and generates a command current to move the rack to the target rack position. Therefore, there may be estimated the fact that the steering motor 70 does not operate is likely to have an error or a problem occurred in the series of processes.

On the other hand, if the vehicle is driving on a straight section and it is detected that the steering motor 70 is operating, the first steering control module 100 and the second steering control module 200 may determine that the first steering control module 100 fails.

As described above, in the steering control device 10 of the present disclosure, each of the first steering control module 100 and the second steering control module 200 may include a separate MPS. In addition, if data is not transmitted/received through internal CAN, it is possible to determine a failure of the steering control module maintaining the control right through each MPS.

In the first steering control module 100 and the second steering control module 200, each MPS may serve as an alternative to the existing failure detection method, in addition, each MPS may detect the position of the steering motor 70 at all times to complement the existing failure detection.

The first steering control module 100 and the second steering control module 200 may be implemented as an electronic controller unit (ECU), a microcomputer, or the like.

In an embodiment, a computer system (not shown) such as the first steering control module 100 and the second steering control module 200 may be implemented as an electronic control unit (ECU). The electronic control unit may include at least one or more elements of one or more processors, memories, storage unit, user interface input unit and user interface output unit, which may communicate with each other via a bus. Furthermore, the electronic control unit may also comprise a network interface for connecting to the network. The processor may be a CPU or a semiconductor device that executes processing instructions stored in memory and/or storage unit. Memory and storage unit may include various types of volatile/non-volatile storage media. For example, memory may include ROM and RAM.

Hereinafter, it will be described a steering control method using the steering control device 10 capable of performing all of the above-described present disclosure.

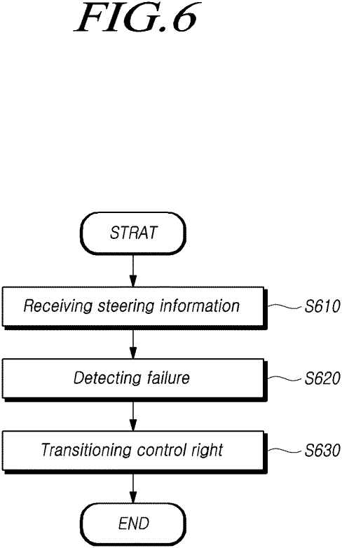

FIG. 6 is a flowchart illustrating a steering control method according to an embodiment of the present disclosure.

Referring to FIG. 6, the steering control method according to the present disclosure may include a steering information receiving step of receiving steering information from a first steering control module 100 (S610), a failure detection step of detecting failure of the first steering control module 100 based on steering information (S620), and a control right transitioning step of transitioning the control right of the steering motor 70 to the second steering control module 200 in the case of a failure of the first steering control module 100 (S630).

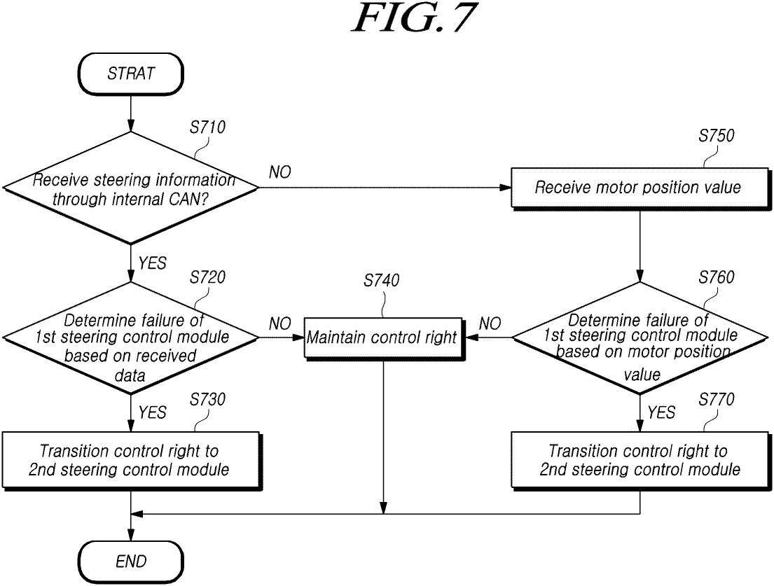

FIG. 7 is a diagram for explaining step S620 in detail according to an embodiment.

Referring to FIG. 7, the second steering control module 200 may receive steering information through the internal CAN (S710). The steering information can be received by both the first steering control module 100 and the second steering control module 200. In this case, each of the first steering control module 100 and the second steering control module 200 may transmit the received information to each other through the internal CAN and compare each information, thereby increasing the reliability of the steering information. In addition, the second steering control module 200 may receive information about the state of the first steering control module 100 through the internal CAN. For example, the information about the state of the first steering control module 100 may include information on a failure or abnormality of the first steering control module 100 determined by the first steering control module 100 itself.

If the steering information is received through the internal CAN (YES in S710), the second steering control module 200 may determine whether of a failure of the first steering control module 100 based on the received data (S720).

If it is determined that the first steering control module 100 fails (YES in S720), the second steering control module 200 may receive the control right of the steering motor 70, and may replace the role of the first steering control module 100 (S720). That is, the second steering control module 200 may generate a second command current to provide a steering assistance force to the steering wheel. The second command current may be a control signal for moving the rack to the target rack position determined by the second steering control module 200.

If it is determined that the first steering control module 100 does not fail (NO in S720), the control right may not be transitioned to the second steering control module 200, and the first steering control module 100 may maintain the control right (S740).

If the steering information is not received through the internal CAN (NO in S710), the second steering control module 200 may receive a motor position value of the steering motor 70 through the second MPS 240 (S750). The motor position value may always be received as long as the second MPS 240 operates normally rather than received only when data such as steering information is not received from the internal CAN.

As described above, if the steering information and the like are not received from the first steering control module 100, the second steering control module 200 may determine whether of a failure of the first steering control module 100 based on the position of the steering motor.

The second steering control module 200 may determine a failure of the first steering control module 100 based on the motor position value (S760).

In one embodiment, the second steering control module 200 may determine whether of a failure of the first steering control module based on an estimated rack position estimated by moving a rack as the steering motor rotates and the target rack position. That is, it is possible to determine whether the first steering control module 100 fails based on the difference between the estimated rack position and the target rack position.

In another embodiment, the second steering control module 200 may determine the failure of the first steering control module 100 when it is detected that the steering motor 70 does not rotate while the steering wheel is rotating. Conversely, if it is detected that the vehicle is driving straight and the steering motor 70 rotates, there may be determined that the first steering control module 100 fails.

If it is determined that the first steering control module 100 fails (YES in S760), the second steering control module 200 may receive the control right of the steering motor 70, and may replace the role of the first steering control module 100 (S770).

If it is determined that the first steering control module 100 does not fail (NO in S760), the control right may not transitioned to the second steering control module 200, and the first steering control module 100 may maintain the control right (S740).

As described above, according to the present disclosure, the steering control device and method may provide a redundant effect as an alternative to the CAN communication by detecting the rotation of a steering motor in each MPS. In addition, it is possible to improve the driving stability by supplementing configuration for determining a failure of the steering control module.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A steering control device comprising:
a first steering control module configured to receive steering information, determine a target rack position based on the steering information, and generate a first command current to control a steering motor so that a rack moves to the target rack position; and
a second steering control module configured to receive a control right for the steering motor if the first steering control module fails, and generate a second command current for controlling the steering motor.

2. The steering control device of claim 1, wherein the first steering control module comprises:
a receiver configured to receive the steering information from at least one of a speed sensor, a steering angle sensor, and a torque sensor;
a determiner configured to determine the target rack position based on the steering information; and
a controller configured to generate the first command current so that the rack moves to the target rack position.

3. The steering control device of claim 2, wherein the first steering control module further comprises a first motor position sensor (MPS) for detecting a position of the steering motor, and the first steering control module determines whether the first steering control module fails based on the position of the steering motor.

4. The steering control device of claim 1, wherein the second steering control module further comprises a second motor position sensor (MPS) for detecting a position of the steering motor, and the second steering control module determines whether the first steering control module fails based on the position of the steering motor.

5. The steering control device of claim 1, wherein the first steering control module transmits and receives steering information with the second steering control module through an internal controller area network (CAN).

6. The steering control device of claim 3, wherein the first steering control module determines whether the first steering control module fails based on an estimated rack position estimated by moving a rack as the steering motor rotates and the target rack position.

7. The steering control device of claim 4, wherein the second steering control module determines, if the steering information is not received from the first steering control module, whether the first steering control module fails based on a position of the steering motor detected by the second MPS.

8. The steering control device of claim 3, wherein the first steering control module determines that the first steering control module fails if it is detected that the steering motor does not rotate while a steering wheel is rotating.

9. A steering control method comprising:
receiving steering information from a first steering control module;
detecting a failure of the first steering control module based on the steering information; and
transitioning a control right of a steering motor, if it is determined that the first steering control module fails, to a second steering control module.

10. The steering control method of claim 9, wherein the receiving comprises further receiving a position of the steering motor, and the determining comprises determining whether the first steering control module fails based on the position of the steering motor.

11. The steering control method of claim 9, wherein the first steering control module transmits and receives steering information with the second steering control module through an internal controller area network (CAN).

12. The steering control method of claim 10, wherein the detecting comprises determining whether the first steering control module fails based on an estimated rack position estimated by moving a rack as the steering motor rotates and a target rack position.

13. The steering control method of claim 10, wherein the detecting comprises determining, if the steering information is not received from the first steering control module, whether the first steering control module fails based on the position of the steering motor.

14. The steering control method of claim 10, wherein the detecting comprises determining that the first steering control module fails if it is detected that the steering motor does not rotate while a steering wheel is rotating.
